(19) United States
(12) Patent Application Publication
(10) Pub. No.: US 2024/0113947 A1
(43) Pub. Date: Apr. 4, 2024

(54) NETWORK NODE AND METHOD FOR HANDLING OPERATIONS IN A COMMUNICATIONS NETWORK

(71) Applicant: Telefonaktiebolaget LM Ericsson (publ), Stockholm (SE)

(72) Inventors: Perepu SATHEESH KUMAR, Chennai (IN); Saravanan M, Chennai (IN)

(73) Assignee: Telefonaktiebolaget LM Ericsson (publ), Stockholm (SE)

(21) Appl. No.: 18/265,306

(22) PCT Filed: Dec. 11, 2020
(86) PCT No.: PCT/IN2020/051019

§ 371 Date: Jun. 5, 2023

(51) Int. Cl. H04L 41/5009; H04L 41/0654; H04L 41/5019

(52) U.S. Cl. CPC H04L 41/5009; H04L 41/0654; H04L 41/5019

(57) ABSTRACT

Embodiments herein may e.g. relate to a method performed by a network node (12) for handling one or more operations in a communications network comprising a plurality of computing devices (10,11) performing one or more tasks. The network node (12) obtains an indication of a failure of an operation in the communications network; and obtains one or more parameters to resolve the failure. The one or more parameters relate to resources of the plurality of computing devices (10,11) and the communications network (1), wherein the one or more parameters are structured in an hierarchic manner and defined by a task of a capability, a resource used for the task, and a service level for the task. The network node (12) generates a plan by taking an aimed service level into account as well as the obtained one or more parameters; and executes one or more operations using the generated plan.

### TECHNICAL FIELD

Embodiments herein relate to a network node and a method performed therein. Furthermore, a computer program product and a computer readable storage medium are also provided herein. In particular, embodiments herein relate to handling operations in a communications network.

### BACKGROUND

In a typical communications network, computing devices, also known as process devices, wireless communication devices, robot devices, operational devices, mobile stations, vehicles, stations (STA) and/or wireless devices, communicate with one or another or with a server or similar via a Radio access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node. The radio network node may comprise one or more antennas providing radio coverage over one or more cells.

With the advent of Industry 4.0 factories and retail warehouses, teams of computing devices such as multi-robot teams are expected to coordinate operations among themselves to complete complex tasks. As the individual robots have limited on board processing capacities, some tasks are to be offloaded to other robots, edge devices or the cloud in order to complete tasks within time limits. This will employ a complex multi-robot coordination, ensuring that the communication channels are available for task offloading, splitting up offloaded computations and ensuring that high level goals are met.

Cloud robotics, in particular, automated collaboration among multiple robots across distributed cloud and edge, actually involves multiple parties including human participants, multiple robots, networking equipment, compute nodes and quality of service (QoS) policies. And this collaboration needs to meet user specified goals under stringent Service Level Agreements (SLA) also specified by the user. This entails the user specifying their requirements, also called intents in this document, via an interface that translates these intents into actionable tasks. These tasks should then be assigned to appropriate compute nodes that can implement the task while adhering to the SLA requirements. This also involves data transmission across compute nodes in order to meet the SLA requirements, since such computations would be data-intensive.

### SUMMARY

As part of developing embodiments herein a problem has been defined. It is required a model to decouple resources in a unified fashion, so that they may be represented as atomic blocks, e.g. single sensing resource within a robot. Composition of these atomic resources results in completion of SLA constrained tasks in an automated fashion.

It is natural to expect that failures would occur during task execution, leaving tasks unfinished or partially finished. In such a situation, suitable replacement for the failed service that was executing the task in question, needs to be found. This will be from either existing services or will have to be discovered via a marketplace and selected in order to meet the SLA requirements. The failure resolution thus targets two sets of requirements:
Failure in estimating and scheduling the correct resource (robotic, compute, network slice) to complete the tasks within the given SLA.
Node failures due to hardware faults, environment conditions or overloading, leading to task failures.

Both these features should be handled in an automated fashion, without delays or extended human intervention.

There are no present solutions that address the above in an integrated fashion. Thus, there is no integrated solution that provides an integrated solution for SLA-driven cloud robotic collaboration that also considers failure handling across the distributed cloud and edge. A unified model to integrate sensing, robot actuation, computing, data transmission and SLA decomposition is needed.

Current problems that may exist:
SLA linked to static deployments with no exposure of available resources. This leads to under-utilization of available resources. Allocating resources to match given SLA requirements dynamically is not possible.
What is missing is a unified model to look at sensors, motors, actuators, compute nodes, network nodes as individual atomic components in the resource pool. What is needed: both cyber-physical systems/robotics and computing power treated as resources, capable of being composed to match required SLA.
Failure resolution is handled through manual intervention or expensive redundancies, e.g. high available computing resources, duplicating robotic tasks, inefficient network usage, which is neither scalable, nor conformant to goal driven cloud robotics orchestrations.

An object of embodiments herein is, therefore, to improve coordination of operations for a plurality of computing devices in a dynamical and efficient manner.

According to an aspect of embodiments herein, the object is achieved by a method performed by a network node for handling one or more operations in a communications network comprising a plurality of computing devices performing one or more tasks. The network node obtains an indication of a failure of an operation in the communications network; and obtains one or more parameters to resolve the failure. The one or more parameters relate to resources of the plurality of computing devices and the communications network, wherein the one or more parameters are structured in an hierarchic manner and defined by a task of a capability, a resource used for the task, and a service level for the task. The network node generates a plan by taking an aimed service level into account as well as the obtained one or more parameters; and executes one or more operations using the generated plan.

It is furthermore provided herein a computer program product comprising instructions, which, when executed on at least one processor, cause the at least one processor to carry out any of the methods above, as performed by the network node. It is additionally provided herein a computer-readable storage medium, having stored thereon a computer program product comprising instructions which, when executed on at least one processor, cause the at least one processor to carry out the method according to any of the methods above, as performed by the network node.

According to another aspect of embodiments herein, the object is achieved by providing a network node for handling one or more operations in a communications network comprising a plurality of computing devices performing one or more tasks. The network node is configured to obtain an indication of a failure of an operation in the communications network; and obtain one or more parameters to resolve the failure. The one or more parameters relate to resources of the plurality of computing devices and the communications network, and wherein the one or more parameters are structured in an hierarchic manner and defined by a task of a capability, a resource used for the task, and a service level for the task. The network node is further configured to generate a plan by taking an aimed service level into account as well as the obtained one or more parameters; and to execute one or more operations using the generated plan.

Embodiments herein provide a system wherein the network node generates the plan based on the aimed service level compared to the service level from the obtained one or more parameters. It is herein proposed a robust framework to dynamically match tasks and aimed service level such as SLA requirements with available resources across edge and cloud to deploy them appropriately along with the failure resolution and/or SLA deviation.

One may provide a directory of resources denoted herein as a distributed marketplace across edge and cloud nodes where all currently available resources are listed, including resources from
Cyber—Cloud and Edge Server, Network etc.
Physical—Robots—Sensors, Motors, internet of things (IoT) devices etc.

This allows for searching, matching and replacement in case of failures via e.g. machine learning (ML) methods also known as artificial intelligence (AI) planning techniques. Thus, providing a unified framework, based on a knowledge base of capabilities, to decouple capabilities, resources, tasks and SLA guarantees across cyber-physical nodes.

Embodiments herein may provide:
Integrated intent-aware and SLA-driven task management involving both cyber and physical/robotic entities across all edge and cloud locations.
Usage of a network node e.g. a cloud controller as an oracle to advise on optimum and dynamic selection of resources to meet SLA requirements, and to provide failure resolutions by re-planning and provisioning of alternate resources in the edge/cloud controller's domain
A directory of resources i.e. a marketplace, where all the aforementioned entities are available and accessible as decoupled atomic blocks, whether cyber or physical/robotic, enabling true mix-and-match of these entities for task creation and execution.
AI planning enabled task decomposition and failure resolution, that decomposes high level task and SLA intents to atomic propositions that may be matched dynamically to marketplace resource capabilities.

Embodiments herein provide a scalable architecture, planning strategies and built in reliability for multi-robot tasking. Embodiments herein thus provide manners and apparatuses to improve coordination of multi-computing device operations in a dynamical and efficient manner.

### BRIEF DESCRIPTION OF THE DRAWINGS

Examples of embodiments herein are described in more detail with reference to the attached drawings in which:

FIG. 1 shows a schematic overview depicting a communications network according to a deployment of embodiments herein;

FIG. 2 shows a method performed by a network node according to embodiments herein;

FIG. 3 shows a combined signalling scheme and flowchart depicting embodiments herein;

FIG. 4 shows an architectural overview of embodiments herein;

FIG. 5 shows a combined signalling scheme and flowchart depicting embodiments herein;

FIG. 6 shows a combined signalling scheme and flowchart depicting embodiments herein;

FIG. 7 shows a modelling of one or more parameters according to some embodiments herein; and

FIG. 8 shows a block diagram depicting a network node according to embodiments herein.

### DETAILED DESCRIPTION

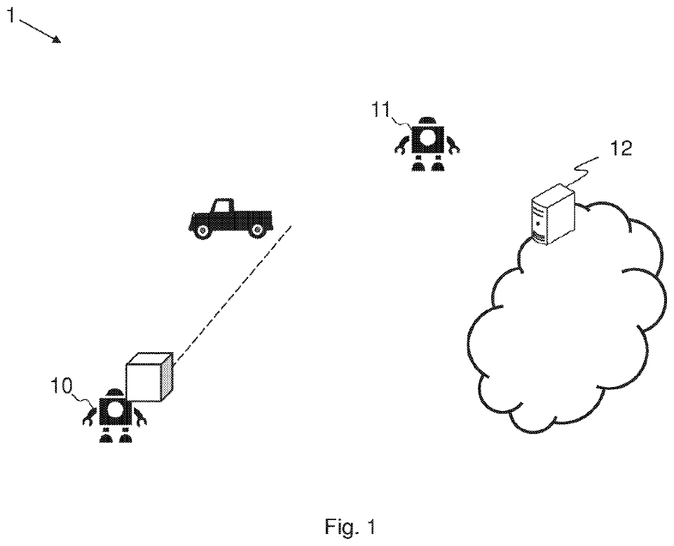

FIG. 1 is a schematic overview depicting a communications network 1 wherein embodiments herein may be implemented. The communications network 1 comprises one or more Radio Access Networks (RANs) and one or more Core Network (CNs). The communications network 1 may use any technology such as 5G new radio (NR) but may further use a number of other different technologies, such as, Wi-Fi, long term evolution (LTE), LTE-Advanced, wideband code division multiple access (WCDMA), global system for mobile communications/enhanced data rate for GSM evolution (GSM/EDGE), worldwide interoperability for microwave access (WiMax), or ultra mobile broadband (UMB), just to mention a few possible implementations.

The communications network 1 comprises a number of computing devices such as robots or similar performing one or more tasks, e.g. a first computing device 10 and a second computing device 11. The computing devices may comprise e.g. process devices, wireless communication devices, robots, operational devices, mobile stations, vehicles, stations (STA) and/or wireless devices. The first computing device 10 may be configured with or collect data along a travelling path regarding one or more tasks of an operation. The second computing device 11 may e.g. off-load the first computing device 10 upon a failure occurrence.

According to embodiments herein the communications network 1 comprises a network node 12 e.g. an access node, a standalone node, a server, a fog node of a cloud, a cloud node or even a computing device with high processing capability. The network node 12 is configured to plan one or more operations involving e.g. the first and second computing devices as well as resource in the communications network 1, such as hardware resources in the communications network 1. The network node 12 may be configured as a distributed node comprising one or more network nodes or parts adjusted to perform embodiments herein.

The network node 12 obtains an indication of a failure of an operation in the communications network, and one or more parameters to resolve the failure. The failure may be e.g. e.g. connection towards an access node of the first computing device or hardware failure of the first computing device. The one or more parameters relate to resources of the plurality of computing devices and the communications network, wherein the one or more parameters are structured in an hierarchic manner and defined by a task of a capability, a resource used for the task, and a service level for the task. The network node 12 generates a plan by taking an aimed service level, e.g. a service level agreement (SLA), into account as well as the obtained one or more parameters; and executes one or more operations using the generated plan.

According to embodiments herein it is here provided a method with focus on the aimed service level enabling Intent aware user requirements. These are automatically decomposed into sub-tasks and SLA requirements, and embodiments herein provide a dynamic allocation of resources to meet the intent in case of deviations or failures. Embodiments herein may use a modelling that provides a framework for decomposition of cyber-physical systems defined by the task of the capability, the resource used for the task, and the service level for the task e.g. Capability, Task-Action, Resource, SLA. This prevents static deployments, which might cause underutilization of edge-cloud-robotic resources. Granular composition of resources prevents underutilization of resources. Using a directory of resources as the framework with the granular composition of resources, denoted as a marketplace, the probability of locating resources to meet SLA guarantees increases, thus resulting in lower chance of deviating from SLA bounds or failure interrupts.

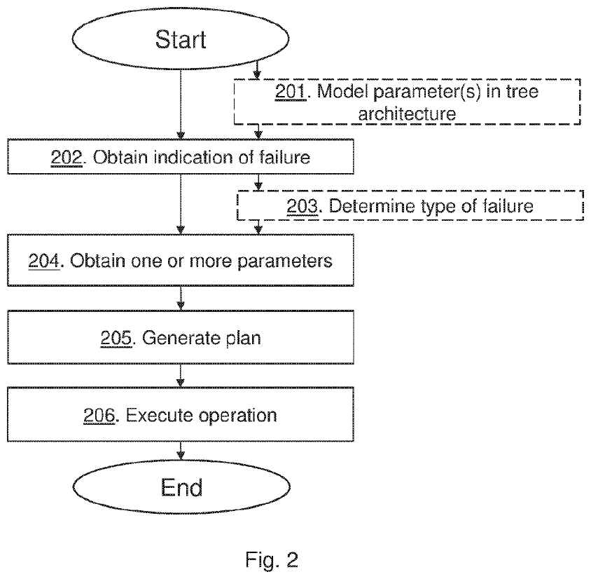

The method actions performed by the network node 12 for handling one or more operations in a communications network 1 comprising a plurality of computing devices 10, 11 performing one or more tasks according to embodiments will now be described with reference to a flowchart depicted in FIG. 2. The actions do not have to be taken in the order stated below, but may be taken in any suitable order. Actions performed in some embodiments are marked with dashed boxes.

Action 201. The network node 12 may model the one or more parameters in a tree architecture based on the task, the resource, and the service level in a directory of resources. The tree architecture may be comprised in the marketplace. The one or more parameters may be structured in the hierarchic manner using a machine learning (ML) model. IT is herein provided an automated warehouse picking, delivery and inventory management system where multiple robots coordinate with compute, network and physical objects in order to complete a high-level goal intent. In order to provide a unified framework to decompose tasks, all resources available in the deployment framework may be exposed as:
(Capability, Task-Action, Resource, SLA)

Examples matching these are provided below:
(Sensing, Identify Object 1, [Depth Sensor, CPU Compute], Accuracy 1)
(Actuation, Move Object 1, [Gripper, Robotic ARM Motor], Accuracy 1)
(Computing, Pattern Match Object 1, [GPU Core, Memory, Disk], Latency 1)
(Data Transmission, Transmit Data 1, [Network Slice 1], [Throughput, Latency])

Action 202. The network node 12 obtains the indication of the failure of an operation in the communications network.

Action 203. The network node 12 may determine a type of failure based on the obtained indication and the one or more parameters are obtained based on the determined type of failure. The failure may comprise a computing device failure, a communication loss, service level failure, and/or a battery degradation.

Action 204. The network node 12 obtains the one or more parameters to resolve the failure, wherein the one or more parameters relate to resources of the plurality of computing devices and the communications network. The one or more parameters are structured in an hierarchic manner and defined by a task of a capability, a resource used for the task, and a service level for the task. The one or more parameters may be retrieved from a database comprising a directory of resources, e.g. the marketplace. The resources of the plurality of computing devices may comprise one or more of the following: computational capability, memory capability, and/or battery capability of the computing devices; and/or the resources of the communications network may comprise one or more of the following: computational capability, and/or memory capability of the communications network.

Action 205. The network node 12 generates the plan by taking an aimed service level into account as well as the obtained one or more parameters. The aimed service level may relate to a goal relating to time, battery usage, computational capacity, and/or communication performance. The generated plan may comprise communication paths, movement paths, operation goals, and/or computational usage in the communications network. The generated plan is negotiated with an external network node to match the service level aim, e.g. negotiated with another controller node, a marketplace or similar.

Action 206. The network node 12 executes one or more operations using the generated plan.

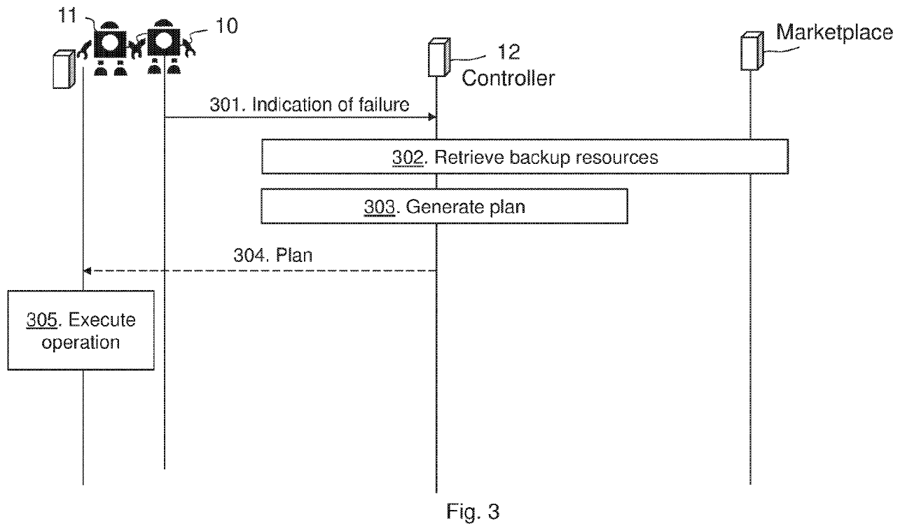

FIG. 3 is a combined signalling scheme and flowchart depicting embodiments herein.

The network node 12 also referred to as the controller may collect or retrieve initial parameters i.e. capabilities of the communications network and/or the computing devices such as the first and second computing devices and may model the tree architecture based on the task, the resource, and the service level.

Action 301. The network node 12 receives indication of failure from a computing device or from the network. The indication may comprise a value, a flag, a message or similar.

Action 302. The network node 12 retrieves backup resources from the marketplace. I.e. the network node 12 may fetch parameters from the marketplace comparing and matching the aimed service level of the operation.

Action 303. Once the backup resources result in the aimed service level, the network node generates a plan.

Action 304. The network node may then transmit data and/or orders to the communications network and/or the computing devices informing or setting up the plan.

Action 305. Receiving device such as the second computing device 11 may then execute the plan.

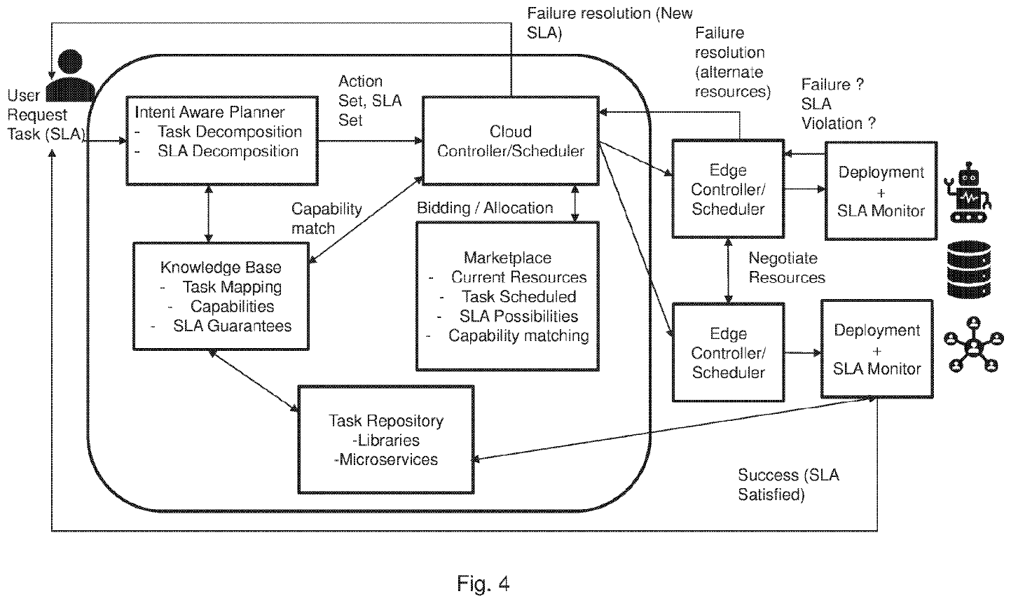

FIG. 4 presents an exemplary architectural overview of embodiments herein. The user interacts with the cloud-based system which is under the control of the Cloud Controller. The user first expresses their intents—including their expected SLAs—to the Intent Aware Planner. The latter then transmits these to the Cloud Controller, which consults the Knowledge Base and Task Repository to determine the appropriate tasks and capabilities that can meet the user requirements. After this, the Cloud Controller then uses the Marketplace to discover and assign the appropriate resources to implement the selected tasks so that user requirements are met.

Once the task execution begins, the Edge Controllers at each region where the tasks are executing, will monitor the task execution to check that it is in line with the SLAs. Here the SLAs that are being monitored are the local SLAs derived from the overall global SLA which was specified by the user. In case of any failure or SLA violation, the Edge Controller has two choices:
Find a replacement resource to address the failure/violation—which could involve negotiation with other Edge Controllers
Escalate to the Cloud Controller so that the latter can use the Marketplace to find a replacement resource

The Cloud Controller in turn would, based on messages received from the Edge Controllers, determine any SLA violations that may arise due to using replacement resources. If any such violation is unavoidable, it will inform the user and this may result in penalties being paid to the user for these SLA violations.

Thus, it is herein provided a network node that may comprise:
a planner that takes the intent and generates a set of actionable sub-tasks. The same planner subdivides the global SLA into local SLAs. The planner has a domain knowledge file with atomic sensing, actuation, compute, network and QoS actions.
an intelligent edge controller is proposed that can assign actionable tasks to available resources. This can take into account heterogeneity of compute power (CPU, memory, load), latency restrictions (network, location) and data processing types (stream, real time, client server).
an intelligent marketplace where all participating resources (robots—sensors, compute nodes, communication offload resources), edge devices, Software-defined networking (SDN) network controller, cloud resources (oracle, last resort compute node) are available and can be used on a pay per use basis
a. Marketplace itself has a resources availability and capabilities library that contains a list of available actionable tasks containing all necessary details such as: sensing/actuation, compute, networking, energy consumption, storage, etc.
a cloud controller analyzes priorities of all marketplace resources (local robots, edge, cloud) depending on the criticality of the SLA. It then assigns resources to task actions with SLA constraints. This allocation is done via appropriate assignments of tasks to the edge controllers responsible for those tasks. The latter in turn does the actual task allocation.

For the tasks under its control, the edge controller will monitor them to ensure that SLAs are not being violated. In case any violation, it has two possible options:
a. Assign the task to alternate resources, despite the traded off cost being high. This is done in one of the following ways:
   i. Solve the problem within the local controllers' domain either by replacing with an equivalent resource or solving the problem sub optimally with required resources.
   ii. Negotiate with other edge controllers to obtain additional resources under their control to which the tasks can be assigned
   iii. Offload this task to the cloud controller, which can then reassign these tasks since it has a global picture of all tasks
b. Re-negotiate SLA with the user, given the current available resources.
If there are hardware or overprovisioning/overloading failures at the node level, due to the unified modeling of resources, alternate resources may be found either at the edge/cloud controller or marketplace level though appropriate matching.

Cloud Controller—Task Definition and Resource Allocation

User's intent can be specified as a conjunction of goals, i.e., G1 AND G2 . . . AND Gn. Each Gi represents a state of the world that needs to be satisfied, i.e., it is a literal that must be made TRUE. Each Gi in turn can be sub-divided into sub-goals Gi1 AND Gi2 AND . . . Gim. Please note that each of these sub-goals could in turn be subdivided into conjunctions or disjunctions of further sub-goals, where disjunctions could represent alternative sub-goals that could meet the overall goal.

For example, an overall goal G1=“Box B1 should be placed onto the truck” could be subdivided into G11=“B1 should be moved from point A to truck” and G12=“B1 should be moved onto truck once at point B”. G12 itself could be subdivided into G121 OR G122, where G121=“lift B1 onto truck” and G122=“push B1 onto truck via ramp”. The exact sub-sub-goal G12i to be chosen, depends on the SLA requirement from the user which could impose a time limit within which this movement needs to be completed—perhaps lifting B1 may be quicker than pushing it using a ramp.

Based on the above, the goals are then continuously subdivided until a level is reached where the leaf-level goals are at the same semantic level [1] as the available tasks in the Task Repository, at which point they can be mapped into the appropriate tasks that can meet the goals and also the SLA requirements at the same time.

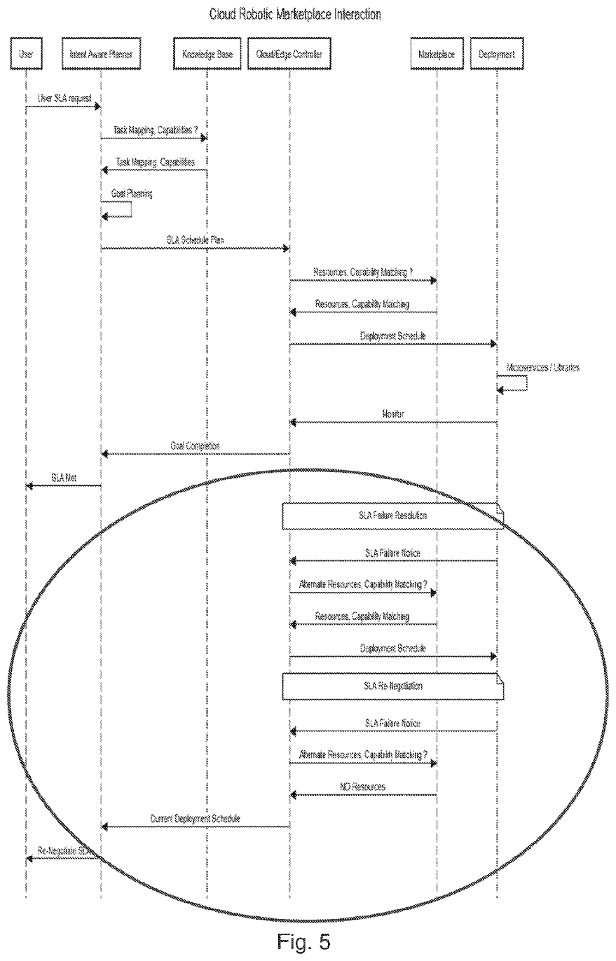

The Cloud Controller would then use these task specifications to find the appropriate resources to execute these tasks, from the Marketplace, as pictorially depicted in FIG. 5, which can be implemented via approaches such as cloud service brokerage.

Edge Controller—Execution Monitoring and Failure Detection

Once the tasks are identified and assigned to the appropriate resources, the overall task sequence is then split among various Edge Controllers depending on where they would be implemented. Once the tasks assigned to an Edge Controller start getting executed, it will keep monitoring them until any of them fails or until successful completion.

A task may experience two types of failures, hardware failures (compute nodes, network, robotic machines) causing abortion of sub-tasks allocated, and scheduling failures (overload, over-estimation) that can cause SLA violations due to delay.
It may take longer than expected—this is due to a combination of factors, such as network (latency/bandwidth) issues, unavailability of shared resources, sub-optimal service/data placement issues, mechanical issues in robots, etc. However, it could eventually complete, albeit unsatisfactorily.
   It may fail completely during execution (hardware, overprovisioning, overloading)
   It may fail partially, i.e., its replacement needs to resume where the failed task left off.
   There might be scheduling/estimation errors, requiring redundancies or alternate resources.

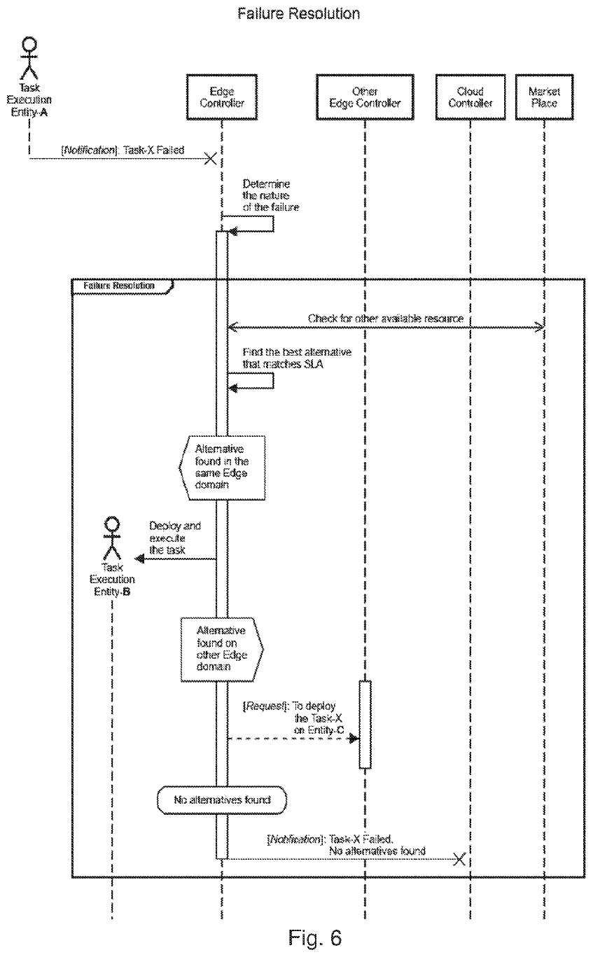

Failure resolution therefore will involve the following steps, pictorially depicted in FIG. 6:
Edge Controller receives failure notification from sensors on participating robot
Edge Controller determines nature of failure
Edge Controller determines whether there is a replacement for the failed/non-performing robot
   It also determines the impact on the promised SLAs as a result of this possible replacement
If this is not satisfactory, Edge Controller negotiates with other Edge Controllers for a suitable replacement with better SLA
If even this does not work, Edge Controller informs Cloud Controller about the failure
Then the Cloud Controller will need to find a suitable replacement via the Marketplace.
Inability to match resources to SLA requirements would finally mean re-negotiating the contract.

It is important to note the following restrictions:
There may be critical tasks steps that cannot be delayed. These critical steps must be allocated resources first, as violation would mean re-deployment/re-negotiation.
We include mechanical/control aspects as part of the resources—motor type, lift capacity, accuracy, range of robot arms, gripper and movements to bring robotics into the forefront. This allows to deal with both cyber-physical and computing/networking system in a unified manner.
Failures are dealt with in a seamless manner across cyber-physical, compute and networking resources. This is done hierarchically, with alternate resources or task actions identified.

It is herein disclosed a solution that is expected to be automated. Given a user request, the system must:
1. Authorize and process user request
2. Generate SLA (prime or not)
3. Locate product
4. Pickup for delivery
5. Pack and ship to address

The knowledge base/planner may run close to the edge controllers to maintain latency constraints. It may be robust enough to meet failures in procurement or scheduling.

The table below describes the task steps. Capabilities and marketplace resources needed to complete sub-tasks within the given SLA.

| | | Resources | | Possible |
|---|---|---|---|---|
| | | from | SLA | Alternate |
| | Capabilities | Market- | Com- | Deployments |
| Task Step | Needed | place | position | due to Failures |
| Authorize | Compute | Compute | Accurate | This is a generic |
| Request | Resource to | Resources | Mapping | task that can be |
| Validity of | input user | [CPU, | Latency | run on any of the |
| User | Data | Memory, | Cost | edge compute |
| Identify | Transmission | Disk] | | nodes. However, |
| Warehouse | Cloud | Network | | link to the central |
| Return | Database | Slice | | server must be |
| validity of | Server to | | | maintained. |
| request | check | | | Low priority |
| | request | | | SLA: |
| | | | | Lower cost |
| | | | | traded off with |
| | | | | more time (run |
| | | | | on edge node). |
| Generate | Planning | Compute | Accurate | Typically, these |
| Shipping | Capability | Resources | Mapping | actions of |
| SLA | Knowledge | [CPU, | Latency | planning, |
| Identify | Mapping | Memory, | Cost | knowledge |
| user | Task | Disk] | | storage, |
| category | Scheduling | Network | | scheduling can |
| Identify | SLA | Slice | | be done on the |
| warehouse | Negotiation | | | cloud. Edge |
| load/ | | | | devices may be |
| expected | | | | used if the |
| time | | | | problem is less |
| Return | | | | complex. |
| expected | | | | Cost traded off |
| Shipping | | | | with accuracy. |
| SLA | | | | |
| Locate | Use the | Compute | Accuracy | Sensors here |
| Product | cloud | Resources | Latency | may be |
| Search for | to locate | [CPU, | Cost | drones/robots |
| product | object. | Memory, | | that have |
| image | Reconfirm | Disk] | | differing |
| Match | the | Network | | capabilities. A |
| product | barcode with | Slice | | lower resolution |
| Return | cloud image. | Sensors | | image may |
| object | This is done | (imaging, | | suffice if the |
| properties | at the edge. | navigation) | | object is well |
| heavy | Match | | | known. A single |
| light/fragile | correct | | | robot/drone may |
| | product to | | | always be |
| | that which | | | assigned this |
| | much be | | | task. |
| | picked up. | | | Cost/flexibility |
| | | | | traded off with |
| | | | | accuracy. |
| Pickup | Path | Compute | Accuracy | One robot may |
| Product | planning, | Resources | Latency | be assigned to |
| Identify | low | [CPU, | Cost | the entire task. |
| robot/ | latency robot | Memory, | | Else there may |
| resources | manipulation | Disk] | | be multiple |
| from | calculation. | Network | | robots |
| marketplace | Offload | Slice | | picking/dropping |
| Move robot | map/ | Sensors | | in zones. |
| to product | location on | (imaging, | | Path planning for |
| (necessary | other robots. | navigation) | | robots may take |
| robot arm) | Local map | Actuation- | | additional |
| Pickup | offloaded. | mobile | | computing |
| object | Robust to | robot | | resources to be |
| Move | connectivity | base | | optimal. |
| drop to | issues | Actuation- | | Time to pickup |
| zone off | | robotic | | products traded |
| Return | | arm | | off with |
| object | | | | cost/additional |
| | | | | resources. |
| Pack and | Sensor to | Compute | Accuracy | Sensors here |
| Deliver | scan image | Resources | Latency | may be |
| Product | and verify | [CPU, | Cost | drones/robots |
| Search for | product | Memory, | | that have |
| product | details. | Disk] | | differing |
| image | Robot arm | Network | | capabilities. |
| Match/ | to pack | Slice | | One robot may |
| identify | product- | Sensors | | be assigned to |
| product | correct | (imaging, | | the entire task. |
| Pack | shipping | navigation) | | Else there may |
| product | address. | Actuation- | | be multiple |
| Ship to | Robot arm to | robotic | | robots |
| correct | drop object | arm | | picking/dropping |
| location | into | | | in zones. |
| | bin/conveyor | | | Robot itself may |
| | loading into | | | take images for |
| | truck. | | | processing. |
| | | | | Latency/accuracy |
| | | | | traded off with |
| | | | | cost. |

### Example of Using an AI Planner to Generate Plans for Composition:

It is herein shown a plan domain and output plans when performing image capture and detection with robotic sensors, robot compute node and edge compute node.

```
Domain of Plan:
  (:predicates (start-image-capture ?x ?y)
        (end-image-capture ?x)
    (start-processing ?x ?y)
    (end-processing ?x)
    (available ?x ?z)
        )
  (:constants true false)
  (:action take_image
      :parameters (?x ?y)
      :precondition
          (and
            (start-image-capture ?x ?y)
            (available ?y true)
            )
      :effect
          (and
            (end-image-capture ?x)
            (available ?y false)
            )
  )
  (:action match_image
      :parameters (?x ?y ?z)
      :precondition
          (and
            (end-image-capture ?x)
            (available ?z true)
        (start-processing ?x ?z)
            )
      :effect
          (and
            (end-processing ?x)
            (available ?z false)
            )
                    )
```

### Plan Under Different Conditions:

### Robot Compute Node is Found

(available robot_sensor true)
(available robot_compute true)
   (available edge_compute true)
;Time 0.00
;ParsingTime 0.00
;NrActions 2
;MakeSpan
;MetricValue
;PlanningTechnique Modified-FF(enforced hill-climbing search) as the subplanner
0.001: (TAKE_IMAGE OBJECT1 ROBOT_SENSOR) [1]
1.002: (MATCH_IMAGE OBJECT1 NETWORK ROBOT_COMPUTE) [1]

### Edge Compute Node is Found

(available robot_sensor true)
(available robot_compute false)—Can also be failure in processing/meeting deadlines
   (available edge_compute true)
Solution found.
;Time 0.00
;ParsingTime 0.00
;NrActions 2
;MakeSpan
;MetricValue
;PlanningTechnique Modified-FF(enforced hill-climbing search) as the subplanner
0.001: (TAKE_IMAGE OBJECT1 ROBOT_SENSOR) [1]
1.002: (MATCH_IMAGE OBJECT1 NETWORK EDGE_COMPUTE) [1]

The ability to decompose cyber-physical systems, compute nodes and networking elements into <capabilities, task-sets, resources, SLAs> allows for much more involved planning approaches.

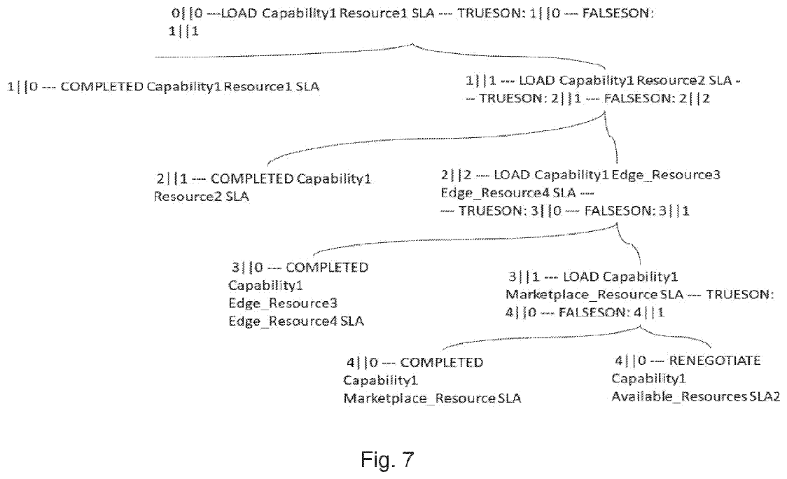

FIG. 7 demonstrates the use of contingent planning with resource decomposition for hierarchical failure resolution. In case the task is unable to be completed with available resources (LOAD Capability1 Resource1 SLA FALSE), the planner loads an alternate resource of similar capability (LOAD Capability1 Resource2 SLA). If this is unavailable, multiple resources that can composed to meet SLA either at the Edge (LOAD Capability1 Edge_Resource3 Edge_Resource4 SLA) or the cloud marketplace (LOAD Capability1 Marketplace_Resource SLA) levels. When this fails, SLA re-negotiation is attempted.

Note that this procedure is automated across robot, IoT, compute, networking and physical resources. The unified planning and reconfiguration framework can adapt to failures and dynamically recognize alternate resources. Such a hierarchical system is required for scalable handling of failures and SLA deviations in cloud robotics environments.

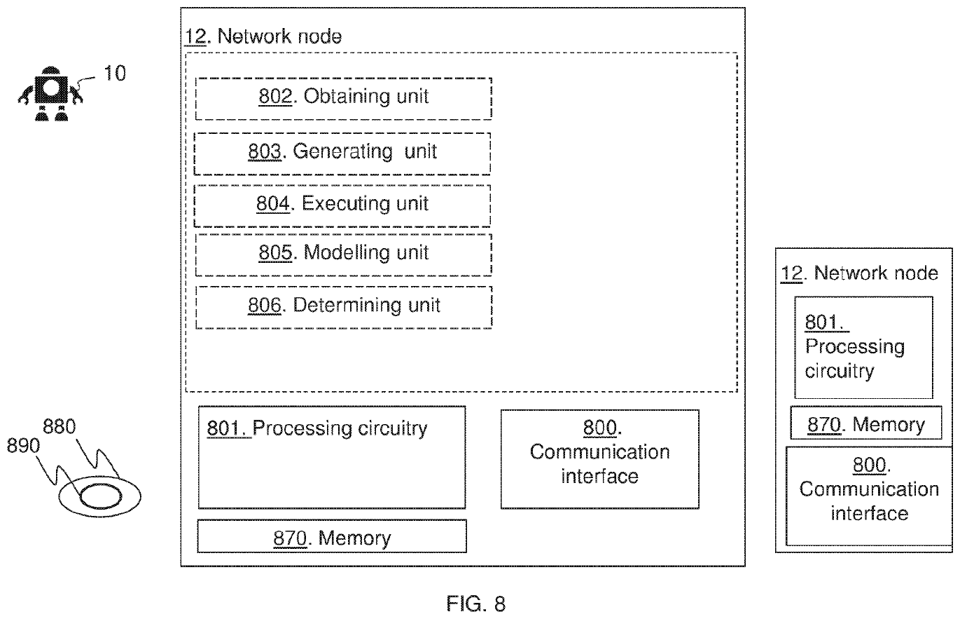

To perform the method actions mentioned above for handling one or more operations in the communications network comprising the plurality of computing devices performing one or more tasks, the network node 12 may comprise an arrangement depicted in two embodiments in FIG. 8.

The network node 12 may comprise a communication interface 800 depicted in FIG. 8, configured to communicate e.g. with the communications network 1 also referred to as a cloud network. The communication interface 800 may comprise a wireless receiver (not shown) and a wireless transmitter (not shown) and e.g. one or more antennas. The embodiments herein may be implemented through a processing circuitry 801 configured to perform the methods herein. The processing circuitry may comprise one or more processors. Thus, it is herein provided a network node comprising processing circuitry and memory, said memory comprising instructions executable by said processing circuitry whereby said network node 12 is operative to perform the methods herein.

The network node 12 may comprise an obtaining unit 802, e.g. receiver, transceiver or retriever. The processing circuitry 801, the network node 12 and/or the obtaining unit 802 is configured to obtain the indication of the failure of the operation in the communications network. The processing circuitry 801, the network node 12 and/or the obtaining unit 802 is further configured to obtain the one or more parameters to resolve the failure, wherein the one or more parameters relate to resources of the plurality of computing devices and the communications network, wherein the one or more parameters are structured in an hierarchic manner and defined by a task of a capability, a resource used for the task, and a service level for the task.

The network node 12 may comprise a generating unit 803, e.g. selector or scheduler. The processing circuitry 801, the network node 12 and/or the generating unit 803 is configured to generate the plan by taking the aimed service level into account as well as the obtained one or more parameters. The generated plan may comprise communication paths, movement paths, operation goals, and/or computational usage in the communications network.

The network node 12 may comprise an executing unit 804, e.g. scheduler or transmitter. The processing circuitry 801, the network node 12 and/or the executing unit 804 is configured to execute the one or more operations using the generated plan. The processing circuitry 801, the network node 12 and/or the executing unit 804 may be configured to negotiate the generated plan with an external network node to match the service level aim.

The network node 12 may comprise a modelling unit 805, e.g. ML model unit. The processing circuitry 801, the network node 12 and/or the modelling unit 805 may be configured to model the one or more parameters in the tree architecture based on the task, the resource, and the service level in the directory of resources, i.e. the market place. The one or more parameters may be structured in the hierarchic manner using a machine learning model.

The network node 12 may comprise a determining unit 806. The processing circuitry 801, the network node 12 and/or the determining unit 806 may be configured to determine type of failure based on the obtained indication and the one or more parameters are obtained based on the determined type of failure.

The processing circuitry 801, the network node 12 and/or the obtaining unit 802 may be configured to obtain to retrieve the one or more parameters from the database comprising the directory of resources.

The network node 12 may be configured as a distributed node with a controller node and a data base with a directory of resources.

The network node 12 may further comprise a memory 870 comprising one or more memory units to store data on. The memory comprises instructions executable by the processor. The memory 870 is arranged to be used to store e.g. measurements, plans, back-up plans, goals, initial parameters, sensing data, events, occurrences, configurations and applications to perform the methods herein when being executed in the network node 12.

Those skilled in the art will also appreciate that the units in the network node 12 mentioned above may refer to a combination of analogue and digital circuits, and/or one or more processors configured with software and/or firmware, e.g. stored in the network node 12, that when executed by the respective one or more processors perform the methods described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, a computer program 890 comprises instructions, which when executed by the respective at least one processor, cause the at least one processor of the network node 12 to perform the actions above.

In some embodiments, a carrier 880 comprises the computer program 890, wherein the carrier 880 is one of an electronic signal, an optical signal, an electromagnetic signal, a magnetic signal, an electric signal, a radio signal, a microwave signal, or a computer-readable storage medium.

When using the word “comprise” or “comprising” it shall be interpreted as non-limiting, i.e. meaning “consist at least of”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a network node for handling one or more operations in a communications network comprising a plurality of computing devices performing one or more tasks, the method comprising:
obtaining an indication of a failure of an operation in the communications network;
obtaining one or more parameters to resolve the failure, wherein the one or more parameters relate to resources of the plurality of computing devices and the communications network, wherein the one or more parameters are structured in an hierarchic manner and defined by a task of a capability, a resource used for the task, and a service level for the task;
generating a plan by taking an aimed service level into account as well as the obtained one or more parameters; and
executing one or more operations using the generated plan.

2. The method according to claim 1, wherein the generated plan comprises communication paths, movement paths, operation goals, and/or computational usage in the communications network.

3. The method according to claim 1, further comprising
modelling the one or more parameters in a tree architecture based on the task, the resource, and the service level in a directory of resources.

4. The method according to claim 1, wherein the generated plan is negotiated with an external network node to match the service level aim.

5. The method according to claim 1, further comprising
determining type of failure based on the obtained indication and the one or more parameters are obtained based on the determined type of failure.

6. The method according to claim 1, wherein the one or more parameters are retrieved from a database comprising a directory of resources.

7. The method according to claim 1, wherein the one or more parameters are structured in the hierarchic manner using a machine learning model.

8. A network node for handling one or more operations in a communications network comprising a plurality of computing devices performing one or more tasks, wherein the network node is configured to:
obtain an indication of a failure of an operation in the communications network;
obtain one or more parameters to resolve the failure, wherein the one or more parameters relate to resources of the plurality of computing devices and the communications network, wherein the one or more parameters are structured in an hierarchic manner and defined by a task of a capability, a resource used for the task, and a service level for the task;
generate a plan by taking an aimed service level into account as well as the obtained one or more parameters; and
execute one or more operations using the generated plan.

9. The network node according to claim 8, wherein the generated plan comprises communication paths, movement paths, operation goals, and/or computational usage in the communications network.

10. The network node according to claim 8, wherein the network node is configured to model the one or more parameters in a tree architecture based on the task, the resource, and the service level in a directory of resources.

11. The network node according to claim 8, wherein the network node is configured to negotiate the generated plan with an external network node to match the service level aim.

12. The network node according to claim 8, wherein the network node is configured to determine type of failure based on the obtained indication and the one or more parameters are obtained based on the determined type of failure.

13. The network node according to claim 8, wherein the network node is configured to retrieve the one or more parameters from a database comprising a directory of resources.

14. The network node according to claim 8, wherein the one or more parameters are structured in the hierarchic manner using a machine learning model.

15. The network node according to claim 8, wherein the network node is configured as a distributed node with a controller node and a data base with a directory of resources.

16. A computer program product comprising instructions on a non-transient computer readable storage medium, which, when executed on at least one processor, cause the at least one processor to carry out the method according to claim 1, as performed by the network node.

17. A tangible, non-transient computer-readable storage medium comprising instructions which, when executed on at least one processor, cause the at least one processor to carry out the method according to claim 1, as performed by the network node.
